(19) United States
(12) Patent Application Publication
(10) Pub. No.: US 2014/0077468 A1
(43) Pub. Date: Mar. 20, 2014

(54) LUGGAGE / CART SYSTEM

(71) Applicant: Jack Lynn Arnold, Estero, FL (US)

(72) Inventor: Jack Lynn Arnold, Estero, FL (US)

(21) Appl. No.: 13/621,287

(22) Filed: Sep. 16, 2012

(51) Int. Cl. B62B 3/02

(52) U.S. Cl. CPC B62B 3/02
USPC 280/38

(57) ABSTRACT

The invention is a new design of luggage/cart system, which you can push or pull. It is in a horizontal position consisting of three or more wheels. The handle is a unique design to extend out and up at any angle. Wheel deployment and retraction is controlled by handle extension and insertion respectively.

### B. CROSS REFERENCE TO RELATED APPLICATIONS

NOT APPLICABLE

### C. STATEMENT REGARDING FEDERALLY SPONSORED RESEARCH OR DEVELOPMENT

NOT APPLICABLE

### D. REFERENCE TO SEQUENCE LISTING, A TABLE, OR A COMPUTER PROGRAM LISTING COMPACT DISC

NOT APPLICABLE

### E. BACKGROUND OF THE INVENTION

### Statement of the Field of Endeavor

The Next Generation of Luggage/Cart System, horizontal positioning design allowing push and pull that is easy to manage, stack and transport.

### References to Specific Documents, Which Are Related to Invention

NOT APPLICABLE

### Applicable, References to Specific Problems Involved in the Prior Art

NOT APPLICABLE

### F. BRIEF SUMMARY OF THE INVENTION

The invention is a new design of luggage/cart system, which you can push or pull. It is in a horizontal position consisting of three or more wheels. The handle is a unique design to extend out and up at any angle. The wheels are deployed and retracted via handle extension and insertion respectively.

### G. BRIEF DESCRIPTION OF THE SEVERAL VIEWS OF THE DRAWING

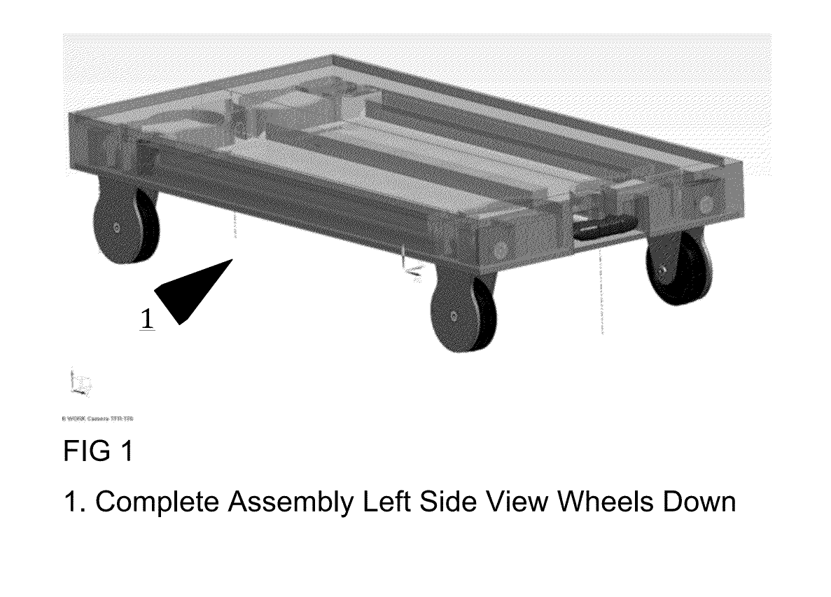

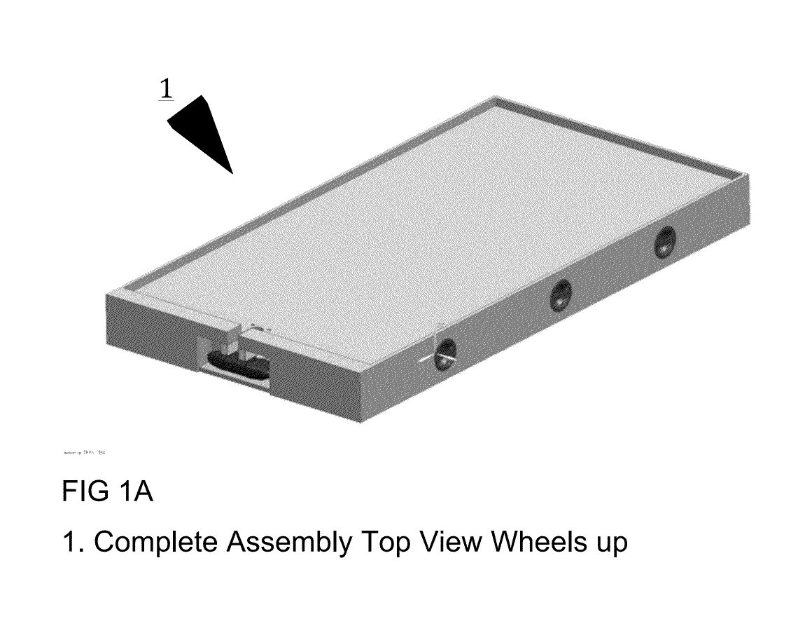

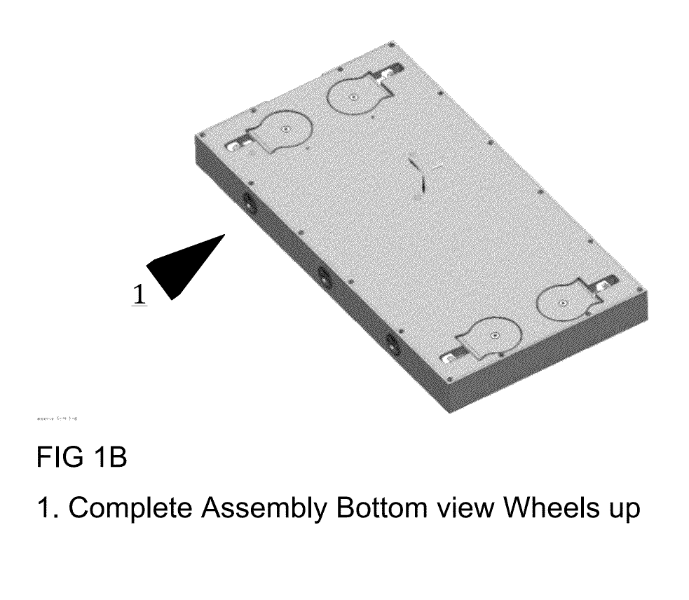

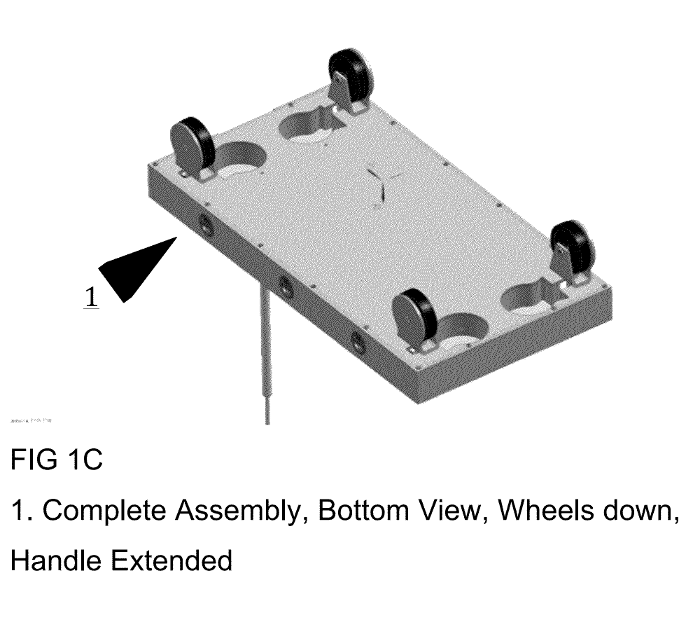

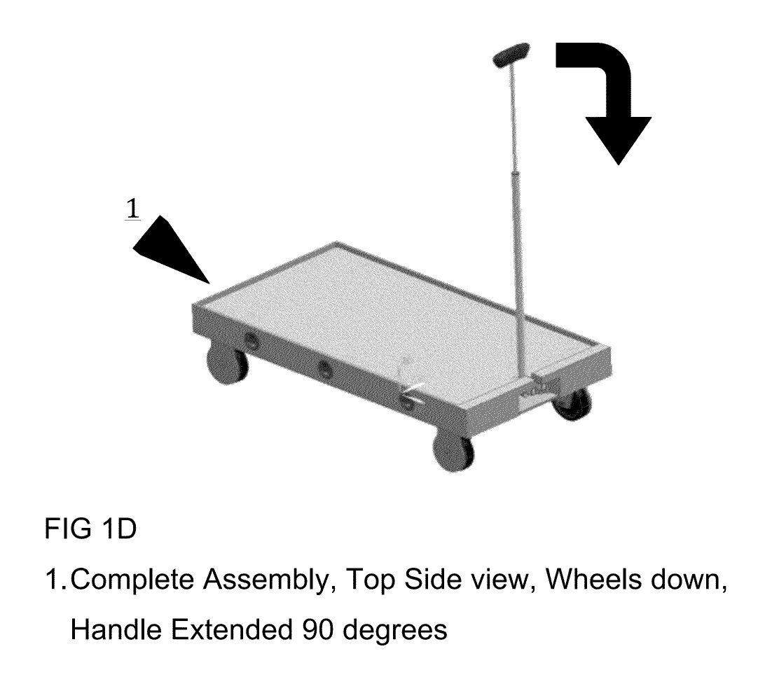

Drawing FIG. 1 Complete Assembly Left Side View, wheels down and handle inserted

Drawing FIG. 1A Complete Assembly, top view, wheels up

Drawing FIG. 1B Complete Assembly, bottom view, wheels up

Drawing FIG. 1C complete Assembly, bottom view, wheels down, handle extended

Drawing FIG. 1D Complete Assembly, top left side view, wheels down, handle extended 90 degrees

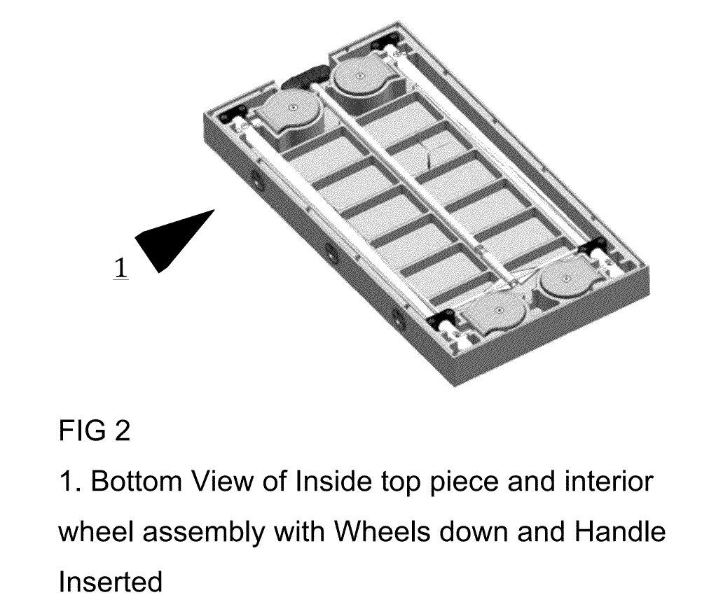

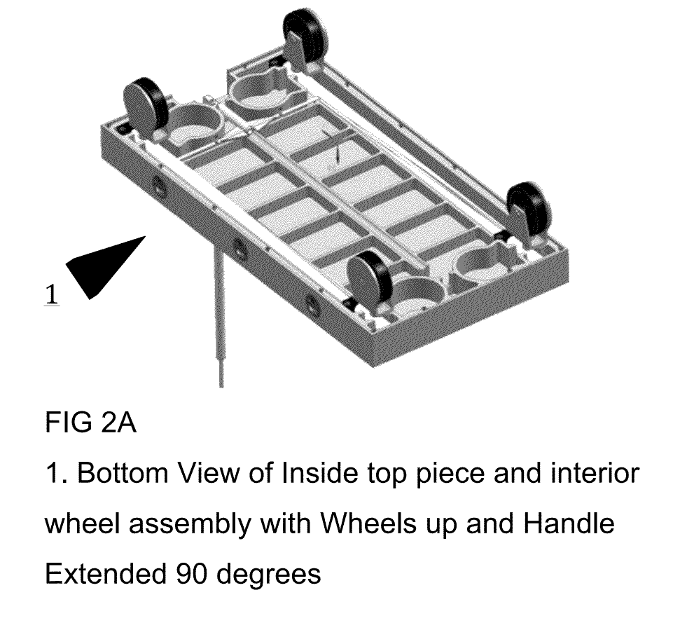

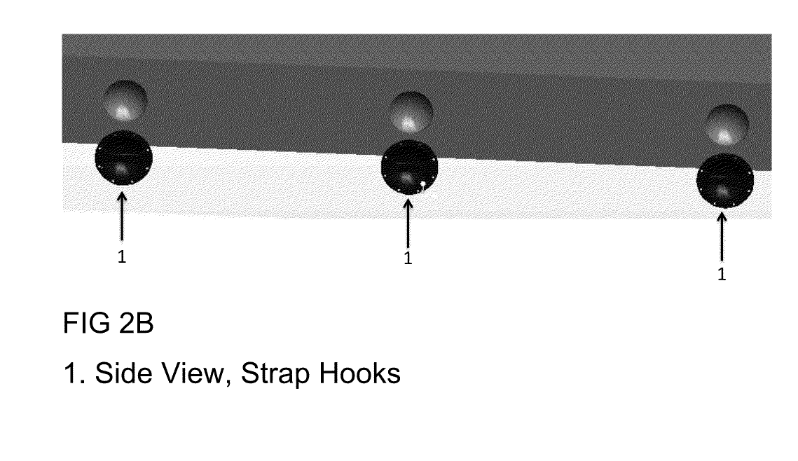

Drawing FIG. 2 Bottom View of Inside top piece and interior wheel assembly with Wheels down and Handle Inserted

Drawing FIG. 2A Bottom view of inside top piece and interior wheel assembly with wheels up and handle extended 90 degrees

Drawing FIG. 2B Side View, Strap Hooks

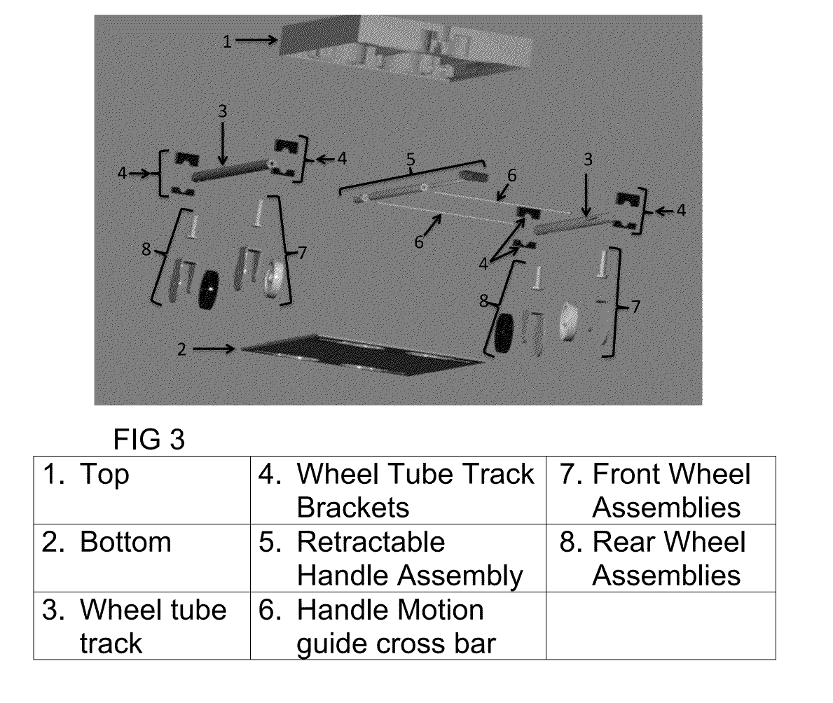

Drawing FIG. 3

1. Top
2. Bottom
3. Wheel Tube Track
4. Wheel Tube Track Brackets
5. Retractable Handle Assembly
6. Handle Motion Guide Cross Bar
7. Front Wheel Assemblies
8. Rear Wheel Assemblies

### H. DETAILED DESCRIPTION OF THE INVENTION

Explanation Along With the process of Making and Using the Invention

This new generation of luggage/cart system design is horizontal with three or more wheels enabling the stacking of luggage utilizing wheel assemblies that can be deployed and retracted into frame. This design also allows for ease in transporting full and empty luggage as well as storage of luggage when not in use.

The making of the luggage will be done utilizing a combination of composite materials and fabric to withstand the environmental elements as well as wear and tear incorporated during transport of luggage/cart system

### Distinguishing Elements From Other Inventions and What is Old

The invention is a new design of luggage, which you can push or pull. It is in a horizontal position consisting of three or more wheels. The handle is a unique design to extend out and up at any angle. Wheel deployment and retraction is controlled by handle extension and insertion respectively.

### Process By Which Invention Will Be Valuable

Value of this invention to the traveler is via the ease of transport by being able to push, pull and stack luggage/materials when in transport.

Value of this invention to consumers is the transporting of craft equipment when traveling, to and from work locations or storage in vehicles as craft demands.

Value of this invention to the Luggage Manufacturing Industry is a new generation of luggage design.

1. A method of deploying and retracting of wheels on transportable luggage/cart system.

2. The method of claim 1, where in the luggage is designed with wheels that can be down for rolling and use or up for storage and stability.

3. A method for pushing and pulling luggage in a horizontal position.

4. The method of claim 2, wherein a piece of luggage can be pushed or pulled with the handle in various degree positions from 180 to 90, given it's 3 or more wheels are deployed in the down position.
